(19) United States
(12) Patent Application Publication
(10) Pub. No.: US 2024/0300130 A1
(43) Pub. Date: Sep. 12, 2024

(54) CLOTH REPLACEMENT APPARATUS AND CLOTH REPLACEMENT MECHANISM

(71) Applicant: Wistron Corporation, New Taipei City (TW)

(72) Inventors: Shun-Chi YEH, New Taipei City (TW); Fu-Hua YAN, New Taipei City (TW); Ze-Shan YAN, New Taipei City (TW); Yu-Long MO, New Taipei City (TW)

(21) Appl. No.: 18/330,579

(22) Filed: Jun. 7, 2023

(30) Foreign Application Priority Data
Mar. 10, 2023 (CN) 202310231546.7

(51) Int. Cl. B26D 1/14; B08B 1/00; B26D 7/01

(52) U.S. Cl. CPC B26D 1/14; B08B 1/143; B26D 7/01

(57) ABSTRACT

A cloth replacement apparatus includes a frame body, a robotic arm, a replacement module, a clamping-pulling module, and a supply module. The robotic arm includes a wiping head. The replacement module includes a base body. The base body has a receiving portion. The wiping head is selectively received in the receiving portion. The clamping-pulling module is movably disposed on the frame body. The supply module includes a cutting assembly. The cutting assembly is movably disposed on the frame body.

### CROSS-REFERENCE TO RELATED APPLICATION

This non-provisional application claims priority under 35 U.S.C. § 119 (a) to patent application Ser. No. 20/231,0231546.7 filed in China on Mar. 10, 2023, the entire contents of which are hereby incorporated by reference.

### BACKGROUND

### Technical Field

A cloth replacement apparatus and a cloth replacement mechanism are provided.

Particularly, a cloth replacement apparatus and a cloth replacement mechanism in which the wiping cloth of the robotic arm can be replaced are provided.

### Related Art

Regarding an automated production system, during the production process of objects, sometimes, the detergents may be left on the surface of the objects, or the adhesives may be run out of the surface of the objects. Hence, a wiping cloth is assembled on a robotic arm, and an automated wiping procedure can be performed with the robotic arm.

However, after the wiping cloth is used for a period of time, the wiping cloth has to be replaced. Currently, the replacement of the wiping cloth is still a manual process, thus making the automated production system fail to achieve full automation. Therefore, the issue for automatically replacing the wiping cloth is to be improved.

### SUMMARY

In view of this, a cloth replacement apparatus is provided and comprises a frame body, a robotic arm, a replacement module, a clamping-pulling module, and a supply module. The robotic arm comprises a wiping head. The replacement module is disposed on the frame body. The replacement module comprises a base body having a receiving portion, and the wiping head is selectively received in the receiving portion. The clamping-pulling module is movably disposed on the frame body. The supply module comprises a cutting assembly, and the cutting assembly is movably disposed on the frame body.

In one embodiment, a cloth replacement mechanism is provided and comprises a frame body, a replacement module, a clamping-pulling module, and a supply module. The replacement module is disposed on the frame body. The replacement module comprises a base body, the base body comprises an engaging assembly, and the engaging assembly is movable. The clamping-pulling module is movably disposed on the frame body. The supply module comprises a cutting assembly movably disposed on the frame body.

Embodiments are provided for facilitating the descriptions of the instant disclosure. However, the embodiments are provided as examples for illustrative purpose, but not a limitation to the instant disclosure. Some elements in the drawings are omitted for clearly showing the technical features of the instant disclosure. In all the figures, the same reference numbers refer to identical or similar elements.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a cloth replacement apparatus according to some embodiments of the instant disclosure;

FIG. 2 illustrates a perspective view of a replacement module according to some embodiments of the instant disclosure;

FIG. 3A illustrates a schematic side view of an engaging member of the replacement module according to some embodiments of the instant disclosure, wherein the engaging member is at an engaged position;

FIG. 3B illustrates a schematic side view of the engaging member of the replacement module according to some embodiments of the instant disclosure, wherein the engaging member is at an unengaged position;

FIG. 3C illustrates a partial perspective view of a robotic arm according to some embodiments of the instant disclosure;

FIG. 4 illustrates a cross-sectional view of the cloth replacement apparatus along the line 4-4 shown in FIG. 1 according to some embodiments of the instant disclosure, wherein the robotic arm enters the receiving portion and the engaging assembly is engaged with the snap ring;

FIG. 5A illustrates a schematic perspective view (1) of a supply module according to some embodiments of the instant disclosure, showing the movements of a first pressing plate and a second pressing plate;

FIG. 5B illustrates a schematic perspective view (2) of the supply module according to some embodiments of the instant disclosure, showing the movements of the first pressing plate and the second pressing plate;

FIG. 6 illustrates a perspective view of a clamping-pulling module according to some embodiments of the instant disclosure;

FIG. 7 illustrates a perspective view of a recycling module according to some embodiments of the instant disclosure;

FIG. 7A illustrates a schematic view of the clamping-pulling module according to some embodiments of the instant disclosure, showing the rotation of the clamping-pulling module;

FIG. 7B illustrates a top view of the replacement module and the recycling module according to some embodiments of the instant disclosure;

FIG. 8 illustrates a schematic view of the cloth replacement apparatus according to some embodiments of the instant disclosure, showing the operation that the robotic arm is to enter the receiving portion;

FIG. 9 illustrates a schematic view of the cloth replacement apparatus according to some embodiments of the instant disclosure, showing the operation that the robotic arm entered the receiving portion and the engaging assembly is engaged with the snap ring;

FIG. 10 illustrates a schematic view of the cloth replacement apparatus according to some embodiments of the instant disclosure, showing the operation that the robotic arm leaves the receiving portion;

FIG. 11 illustrates a schematic view of the cloth replacement apparatus according to some embodiments of the instant disclosure, showing the operation that the clamping-pulling module pulls the wiping cloth out of the supply module;

FIG. 12 illustrates a schematic view of the cloth replacement apparatus according to some embodiments of the instant disclosure, showing the operation that the cutting assembly cuts the wiping cloth and the robotic arm gradually enters the receiving portion; and

FIG. 13 illustrates a schematic view of the cloth replacement apparatus according to some embodiments of the instant disclosure, showing the operation that the robotic arm gradually enters the receiving portion to allow the wiping cloth to be fitted over the wiping head.

### DETAILED DESCRIPTION

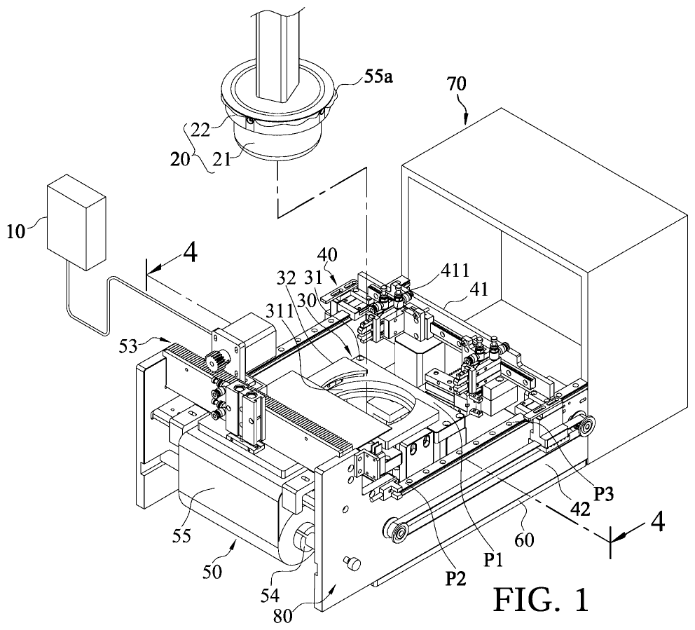

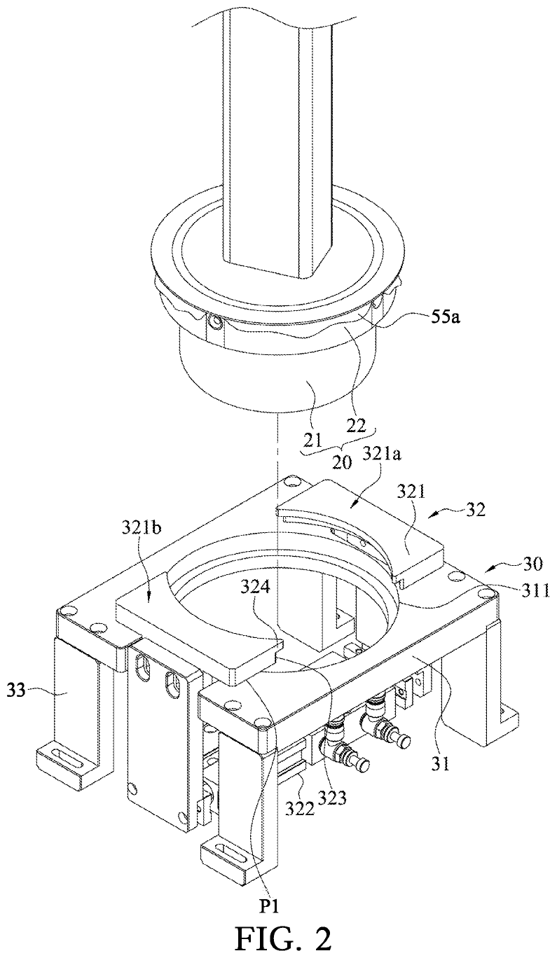

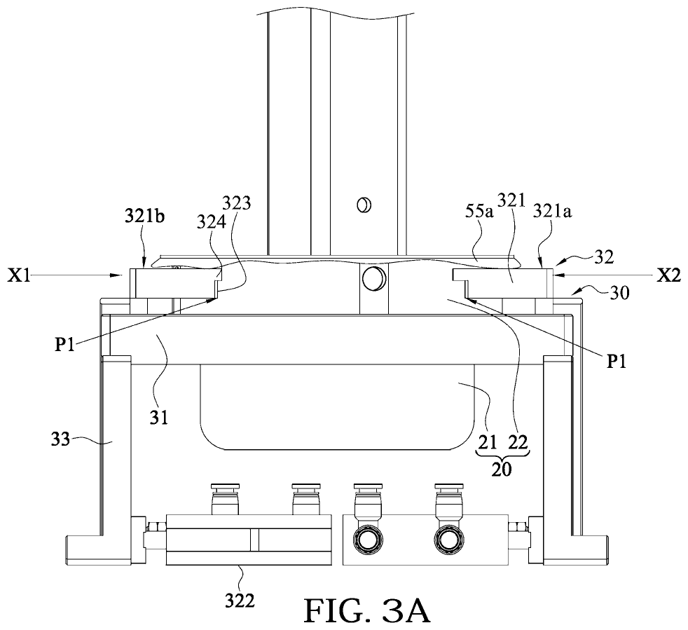

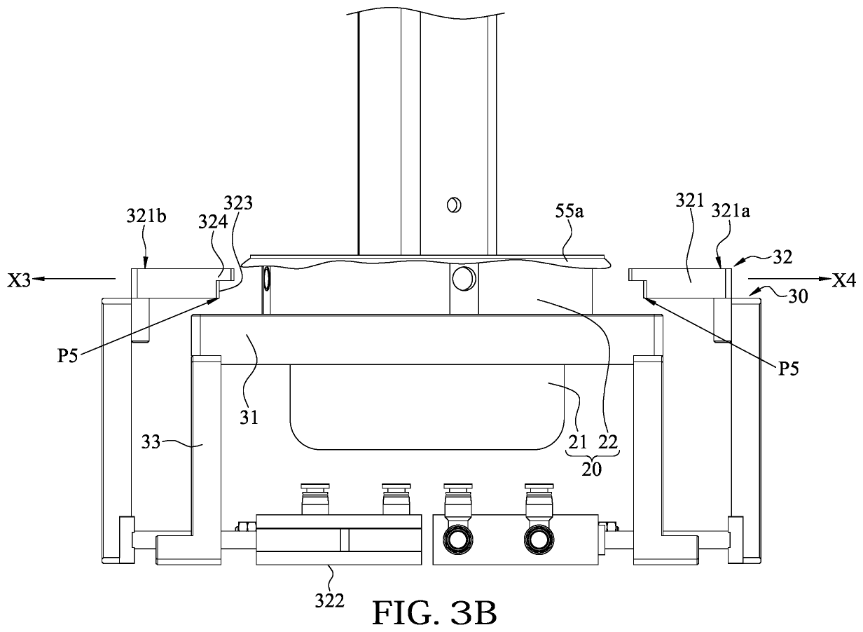

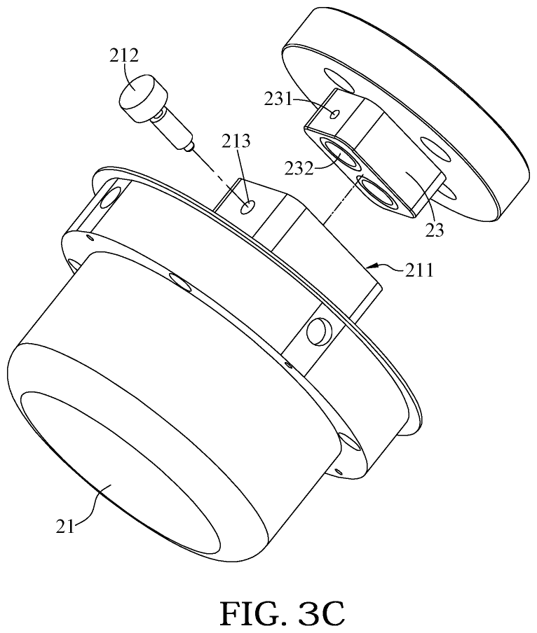

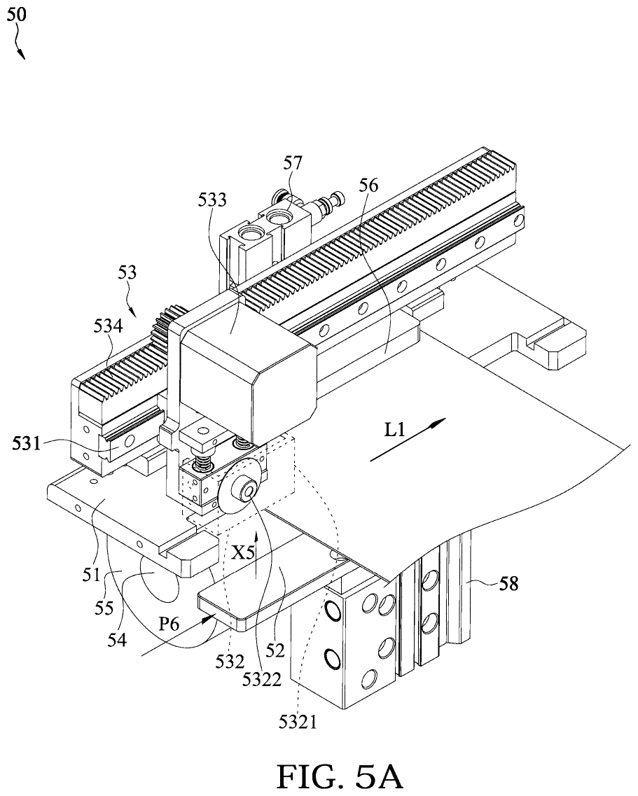

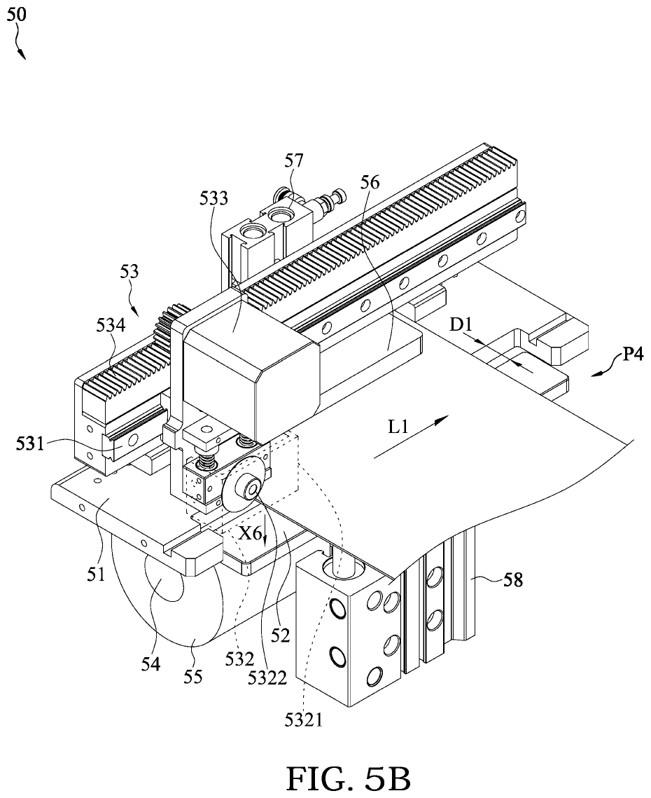

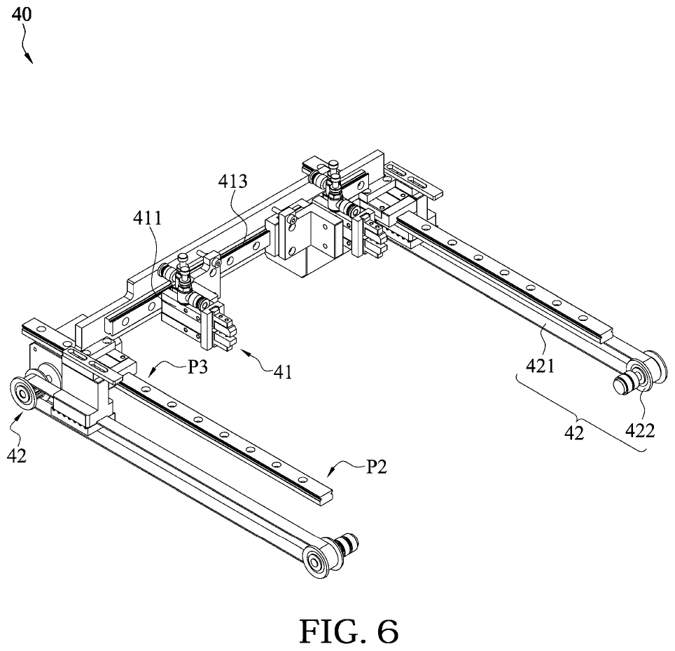

Please refer to FIG. 1. The cloth replacement apparatus comprises a controller 10, a robotic arm 20, a replacement module 30, a clamping-pulling module 40, a supply module 50, a base member 60, a recycling module 70, and a frame body 80. Please refer to FIG. 2 and FIG. 3A. The robotic arm 20 comprises a wiping head 21 and a snap ring 22, and the snap ring 22 is fitted over the wiping head 21. The replacement module 30 comprises a base body 31 and an engaging assembly 32. The base body 31 has a receiving portion 311. The engaging assembly 32 is at two sides of the base body 31 opposite to the receiving portion 311. When the controller 10 executes a detaching procedure, the robotic arm 20 is actuated, so that the wiping head 21 and the snap ring 22 are in the receiving portion 311, the engaging assembly 32 is also actuated and moved to an engaged position P1, so that the engaging assembly 32 is engaged with the snap ring 22, and then the robotic arm 20 is actuated again, so that the snap ring 22 is detached from the wiping head 21 and the wiping head 21 leaves the receiving portion 311. Please also refer to FIG. 6, the clamping-pulling module 40 comprises a clamping assembly 41 and a moving assembly 42. The clamping assembly 41 comprises a first clamp 411. When the controller 10 executes a clamping-pulling procedure, the moving assembly 42 is actuated to move the clamping assembly 41 to a third position P2, the first clamp 411 of the clamping assembly 41 is actuated to perform a clamping action, and then the moving assembly 42 is actuated to move the clamping assembly 41 back to a fourth position P3. Please further refer to FIG. 5A and FIG. 5B, the supply module 50 comprises a loading plate 51, a first pressing plate 52, and a cutting assembly 53. Please refer to FIG. 5A and FIG. 1. The loading plate 51 is adjacent to the third position P2 and has a cutting direction L1. When the controller 10 executes a supply procedure, the first pressing plate 52 is actuated and is moved to a first position P4 (as shown in FIG. 5B), so that a first distance D1 is between the loading plate 51 and the first pressing plate 52, and the cutting assembly 53 is actuated and is moved along the cutting direction L1 by the first distance D1, so that the space for cutting a wiping cloth 55 by the cutting assembly 53 along the cutting direction L1 is provided. Please refer to FIG. 2 and FIG. 3B. When the controller 10 executes a loading procedure, the robotic arm 20 is actuated, so that the wiping head 21 is in the receiving portion 311 and the snap ring 22 is fitted over the wiping head 21, the engaging assembly 32 is actuated and moved to an unengaged position P5, and then the robotic arm 20 is actuated again, so that the wiping head 21 and the snap ring 22 are in the receiving portion 311 or leave the receiving portion 311.

It is understood that, a used wiping cloth 55a is first fitted over the wiping head 21, and then the snap ring 22 is fitted over the wiping head 21 and the used wiping cloth 55a. Therefore, when the used wiping cloth 55a is to be replaced, the snap ring 22 has to be detached first. Consequently, according to one or some embodiments of the instant disclosure, after the controller 10 performs the detaching procedure to actuate the robotic arm 20 to be in the receiving portion 311, the snap ring 22 together with the used wiping cloth 55a are detached from the wiping head 21, and the robotic arm 20 is actuated to leave the receiving portion 311. Then, the controller 10 actuates the clamping assembly 41 and the moving assembly 42 of the clamping-pulling module 40 to pull out the wiping cloth 55 in the supply module 50 and perform a cutting action, and the wiping cloth 55 is arranged on the replacement module 30. After the controller 10 executes the loading procedure to actuate the robotic arm 20 to be in the receiving portion 311, a new wiping cloth 55 is assembled on the wiping head 21, the snap ring 22 is fitted over the wiping head 21 and the wiping cloth 55, and the controller 10 further actuates the robotic arm 20 to leave the receiving portion 311. Accordingly, in one or some embodiments of the instant disclosure, the replacement of the wiping cloth 55 for the robotic arm 20 can be performed automatedly.

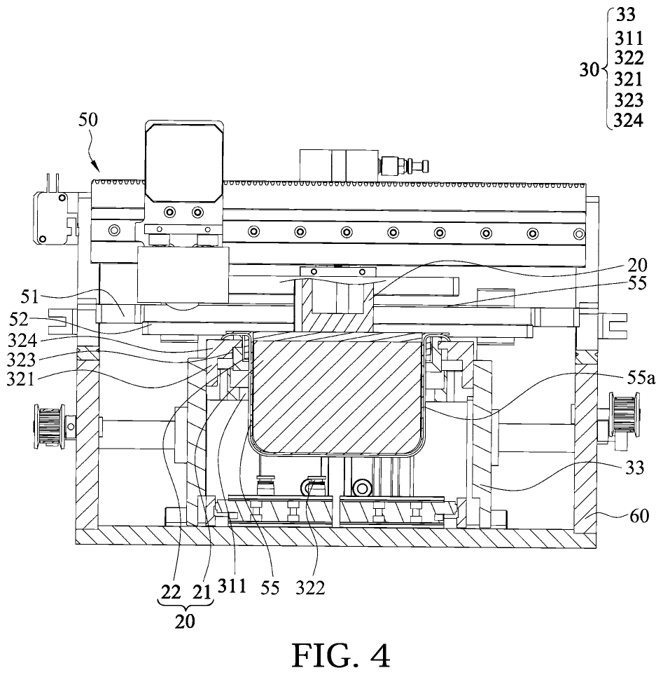

Please refer to FIG. 2, FIG. 3A, and FIG. 3B. In some embodiments, the engaging assembly 32 of the replacement module 30 comprises an engaging member 321 and a second power unit 322. The engaging member 321 has a clamping surface 323, and a flange 324 is on the clamping surface 323. When the controller 10 executes the detaching procedure, the second power unit 322 is actuated to move the engaging member 321 to the engaged position P1 (as shown in FIG. 3A, the arrows X1 and X2 are the moving directions of the engaging member 321); further, as shown in FIG. 3A and FIG. 4, under such condition, the flange 324 abuts against an upper edge of the snap ring 22. Therefore, after the controller 10 actuates the wiping head 21 to move upward, the snap ring 22 is detached from the wiping head 21, and the purpose of detaching the wiping cloth 55 can be thus achieved. In some embodiments, the snap ring 22 is fixed on the wiping head 21 by magnetic attraction; in some embodiments, the snap ring 22, the wiping head 21, and the wiping cloth 55 are closely fitted with one another. In some embodiments, the flange 324 is arranged on a top edge of the clamping surface 323. In some embodiments, the engaged position P1 is a position where the flange 324 of the engaging member 321 abuts against the upper edge of the snap ring 22.

In some embodiments, the clamping surface 323 has a curved surface, and the curved surface corresponds to the curved outer peripheral surface of the snap ring 22; that is, in this embodiment, the curvature of the curved surface of the clamping surface 323 is substantial the same as the curvature of the curved outer peripheral surface of the snap ring 22. Therefore, in the case that the number of the engaging member 321 is one, the clamping surface 323 is formed as a U-shaped structure, and two ends of the U-shaped structure are at two sides of the receiving portion 311, respectively, thereby facilitating the flange 324 to abut against the upper edge of the snap ring 22. In the case that the number of the engaging member 321 is two, as the embodiment shown in FIG. 3A and FIG. 3B, the engaging members 321a, 321b are respectively at two opposite sides of the receiving portion 311 of the base body 21, and the clamping surface 323 is formed as a semicircle-shaped structure; by mating the two engaging member 321a, 321b with each other, the flanges 324 of the engaging member 321a, 321b together abut against the upper edge of the snap ring 22. In the case that the number of the engaging member 321 is three or more, the clamping surface 323 may be curved or flat; when the engaging members 321 are mated with each other, the engaging members 321 together form a circle, but the instant disclosure is not limited thereto, as long as the engaging members 321 and the wiping head 21 can held and positioned with each other in the case that the shape of the wiping head 21 is not circular.

In some embodiments, the second power unit 322 may be a pneumatic cylinder, a hydraulic cylinder, a linear motor, a combination of a motor and a drive mechanism, or the like; as long as the second power unit 322 can drive the engaging member 321 to move to the engaged position P1 or the unengaged position P5, the second power unit 322 falls within the scope sought to be protected by the instant disclosure. In some embodiments, the receiving portion 311 (refer to FIG. 1) is a hole defined through the top portion and the bottom portion of the base body 31. In some embodiments, as shown in FIG. 3B, the unengaged position P5 is a position where the engaging member 321 is moved along the arrows X3, X4 and leaves the engaged position P1.

Please refer to FIG. 2. In some embodiments, four connection legs 33 are on the base body 31. The connection legs 33 allow the base body 31 to be detachably connected to the base member 60 depending on different demands. Therefore, according to one or some embodiments of the instant disclosure, depending on the size of the wiping head 21, a replacement module 30 having a corresponding receiving portion 311 can be replaced.

Please refer to FIG. 1, FIG. 2, FIG. 3A, and FIG. 3B. When the replacement module 30 performs a replacing action for the used wiping cloth 55a, first the detaching procedure is executed through the controller 10, and the robotic arm 20 is actuated, so that the wiping head 21 is moved toward the interior of the receiving portion 311. Then, the controller 10 actuates the second power unit 322 to move the engaging member 321 to the engaged position P1. As shown in FIG. 4, under such condition, the flange 324 abuts against the upper edge of the snap ring 22, and the clamping surface 323 clamps the snap ring 22. Next, the controller 10 actuates the robotic arm 20, so that the wiping head 21 is moved upward and leaves the receiving portion 311. Under such condition, because the flange 324 abuts against the upper edge of the snap ring 22, during the process that the wiping head 21 is moving upward to leave the receiving portion 311, the snap ring 22 and the used wiping cloth 55a are gradually detached from the wiping head 21. Therefore, the detaching action for the snap ring 22 and the used wiping cloth 55a can be achieved. Then, after the new wiping cloth 55 is placed in the receiving portion 311 (which will be described in detail later), the controller 10 executes the loading procedure, the robotic arm 20 is actuated, so that the wiping head 21 is moved toward the interior of the receiving portion 311. During the process that the wiping head 21 is moving toward the interior of the receiving portion 311, the wiping cloth 55 gradually encloses the wiping head 21, and finally the snap ring 22 and the wiping head 21 are closely mated with each other, so that the wiping cloth 55 closely encloses the wiping head 21. Next, the controller 10 actuates the robotic arm 20, so that the wiping head 21 and the snap ring 22 leave the receiving portion 311, and the controller 10 also actuates the engaging member 321 to move to the unengaged position P5. Therefore, the loading action of the snap ring 22 and the wiping cloth 55 can be achieved. It is worthy to mention that, FIG. 4 illustrates a cross-sectional view along the line 4-4 shown in FIG. 1 in a direction from the replacement module 30 to the supply module 50.

Please refer to FIG. 3C. In some embodiments, the robotic arm 20 comprises a connection member 23. A first pin hole 231 and a magnet 232 are on the connection member 23. An insertion groove 211 and a pin 212 are on a top portion of the wiping head 21, one side of the insertion groove 211 has a second pin hole 213, and the pin 212 selectively and sequentially passes through the second pin hole 213 and the first pin hole 231. Therefore, if the wiping head 21 is to be replaced, after the pin 212 is pulled out of the second pin hole 213 and the first pin hole 231, the wiping head 21 can be detached from the apparatus easily. When a new wiping head 21 is installed, after the pin 212 sequentially passes through the second pin hole 213 and the first pin hole 231, the wiping head 21 can be prevented from detaching off the apparatus. Moreover, through the magnetic force of the magnet 232, wiping heads 21 having different sizes can be replaced quickly. Furthermore, it is understood that, the profile of the connection member 23 corresponds to the profile of the insertion groove 211, and the shape of the profile of the connection member 23 and the insertion groove 211 is not limited to rectangular, which also may be square, circular, triangular, or the like. Likewise, the profile of the magnet 232 is not limited to circular, which also may be square, triangular, or the like.

Please refer to FIG. 2 and FIG. 5A. In some embodiments, the supply module comprises a roller 54 and a wiping cloth 55, and the wiping cloth 55 surrounds the roller 54. After the wiping cloth 55 is pulled by the clamping-pulling module 40, the wiping cloth 55 is cut by the cutting assembly 53, and the cut wiping cloth 55 can enclose the whole wiping head 21.

Please refer to FIG. 5A. In some embodiments, the cutting assembly 53 comprises a first rail 531, a round knife assembly 532, and a first power unit 533, and a length direction of the first rail 531 is parallel to the cutting direction L1. The first power unit 533 is disposed on the first rail 531. The round knife assembly 532 is disposed on the first power unit 533. Therefore, through the movement of the first power unit 533 along the first rail 531, the round knife assembly 532 is driven by the first power unit 533 to move along the cutting direction L1 and cut the wiping cloth 55.

Furthermore, the first power unit 533 may be a may be a cylinder, a linear motor, a combination of a motor and a drive mechanism, or the like; as long as the first power unit 533 can drive the cutting assembly 53 to move along the cutting direction L1, the first power unit 533 falls within the scope sought to be protected by the instant disclosure. Please refer to FIG. 5A. In some embodiments, the cutting assembly 53 comprises a tooth rack 534, and the tooth rack 534 is disposed above the first rail 531. The first power unit 533 is a motor, and the output end of the motor is engaged with the tooth rack 534. When the first power unit 533 is activated, through the engagement between the output end of the first power unit 533 and the rack 534, the first power unit 533 is moved along the first rail 531, and the round knife assembly 532 is driven by the first power unit 533 to perform a cutting action along the cutting direction L1.

Please refer to FIG. 5A. In some embodiments, the round knife assembly 532 comprises a housing 5321 and a round knife 5322, the round knife 5322 is disposed on the housing 5321, and the round knife 5322 protrudes out of a bottom surface of the housing 5321. By enclosing the round knife 5322 with the housing 5321, the round knife 5322 will only contact the wiping cloth 55. As shown, the bottom surface of the housing 5321 is a surface of the housing 5321 adjacent to the wiping cloth 55; in order to allow the round knife 5322 to cut the wiping cloth 55, a portion of the round knife 5322 protrudes out of the bottom surface of the housing 5321 for cutting.

Please refer to FIG. 5A and FIG. 5B. In some embodiments, the supply module 50 comprises a second pressing plate 56, and the cutting assembly 53 is between the first pressing plate 52 and the second pressing plate 56. When the controller 10 executes a supply procedure, the controller 10 actuates the second pressing plate 56 to press the loading plate 51 (as shown in FIG. 5A) or to move away from the loading plate 51 (as shown in FIG. 5B). In some embodiments, the supply module 50 comprises a fifth power unit 57 to drive the second pressing plate 56, so that the second pressing plate 56 presses the loading plate 51 or is moved away from the loading plate 51. In some embodiments, the fifth power unit 57 may be a may be a cylinder, a linear motor, a combination of a motor and a drive mechanism, or the like; as long as the fifth power unit 57 can drive the second pressing plate 56 to press the loading plate 51 or to move away from the loading plate 51, the fifth power unit 57 falls within the scope sought to be protected by the instant disclosure. In some embodiments, the supply module 50 comprises a sixth power unit 58, the sixth power unit 58 drives the first pressing plate 52 to move upward from a second position P6 (shown in FIG. 5A) to a first position P4 (shown in FIG. 5B) along the direction indicated by the arrow X5, or the sixth power unit 58 drives the first pressing plate 52 to move downward from the first position P4 (shown in FIG. 5B) to the second position P6 (shown in FIG. 5A) along the direction indicated by the arrow X6.

Please refer to FIG. 1 and FIG. 6. The controller 10 executes the clamping-pulling procedure to actuate the clamping assembly 41, so that the clamping assembly 41 is moved from a fourth position P3 to a third position P2. Next, the first clamp 411 performs a clamping action to the wiping cloth 55, and the controller 10 actuates the moving assembly 42, so that the clamping assembly 41 is moved from the third position P2 to the fourth position P3. Under this condition, the wiping cloth 55 is pulled into the receiving portion 311. Then, as shown in FIG. 5A and FIG. 5B, the controller 10 executes the supply procedure to actuate the first pressing plate 52 to move to the first position P4 and actuate the second pressing plate 56 to move toward the loading plate 51 to press the wiping cloth 55, so that the condition of the supply module 50 is changed from FIG. 5A to FIG. 5B. Next, the controller 10 actuates the cutting assembly 53 to move along the cutting direction L1, so that the round knife 5322 cuts the wiping cloth 55. Because the first pressing plate 52 and the second pressing plate 56 together press the wiping cloth 55, and the wiping cloth 55 is pulled by the clamping assembly 41, a tension force is generated on the wiping cloth 55, so that the round knife 5322 can cut the wiping cloth 55 easily. Through the foregoing steps, the supply module 50 can provide the new wiping cloth 55. Moreover, in some embodiments, the third position P2 is a position where the clamping assembly 41 can perform a clamping action to the wiping cloth 55 output by the supply module 50; when the clamping assembly 41 pulls the wiping cloth 55 to the base body 31, the position of the clamping assembly 41 is the fourth position P3.

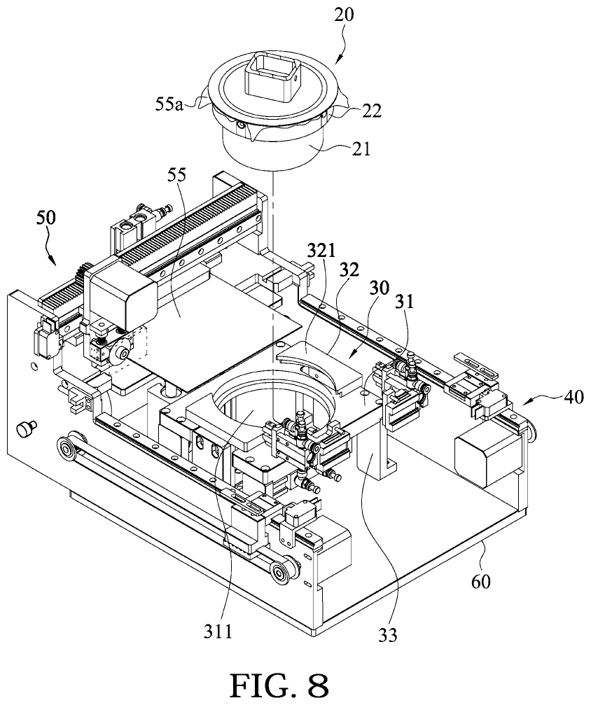

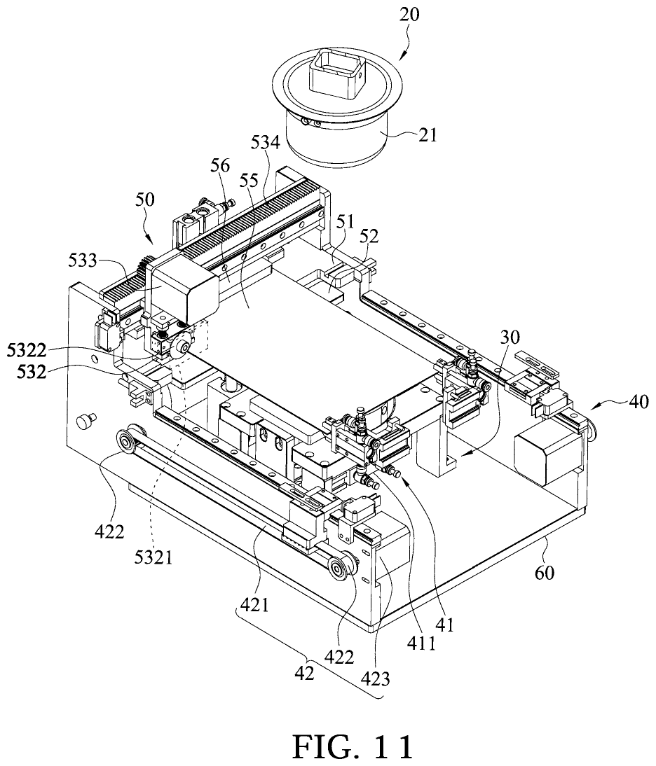

Please refer to FIG. 1, FIG. 6, FIG. 8, and FIG. 11. In some embodiments, the moving assembly 42 comprises a drive belt 421, two drive wheels 422, and a third power unit 423. The two drive wheels 422 are arranged separately, the drive belt 421 is arranged over the two drive wheels 422, and the third power unit 423 is power-connected to one of the two drive wheels 422. The clamping assembly 41 is disposed on the drive belt 421 and between two drive wheels 422. After the third power unit 423 is activated, the third power unit 423 drives the drive wheels 422 to rotate, so that the drive wheels 422 drive the drive belt 421 to rotate and drive the clamping assembly 41 to move. Therefore, by using the third power unit 423 to drive the drive wheels 422 to rotate clockwise or counterclockwise, the drive wheels 422 drive the clamping assembly 41 to the third position P2 or the fourth position P3. Moreover, in some embodiments, the number of the drive belt 421 is two, the number of the drive wheel 422 is four, the number of the third power unit 423 is two, and one drive belt 421, two drive wheels 422, and one third power unit 423 are disposed on each of two opposite sides of the base member 60. Accordingly, the movement of the clamping assembly 41 can be achieved stably.

Please refer to FIG. 6. In some embodiments, the clamping assembly 41 comprises a third rail 413, and the first clamp 411 is slidably disposed on the third rail 413. Therefore, according to one or some embodiments of the instant disclosure, depending on different demands, the first clamp 411 is operated and slides to a certain position, so that the first clamp 411 can clamp the wiping cloth 55 conveniently. Moreover, in the case that the number of the first clamp 411 is two, not only the wiping cloth 55 can be stably clamped and moved to a certain position, but also the distance between the two first clamps 411 is adjustable by sliding the two first clamps 411.

Please refer to FIG. 1 and FIG. 6. Upon the operation of the clamping-pulling module 40, the controller 10 executes the clamping-pulling procedure, so that the third power unit 423 is actuated to drive the drive wheels 422 and the drive belt 421 to rotate, thereby controlling the clamping assembly 41 to move to the third position P2. After the first clamp 411 clamps the wiping cloth 55, the controller 10 actuates the third power unit 423 to drive the drive wheels 422 and the drive belt 421 to rotate in a counter direction, thereby controlling the clamping assembly 41 to move to the fourth position P3, and the wiping cloth 55 is pulled into the receiving portion 311. Therefore, the clamping-pulling action is completed.

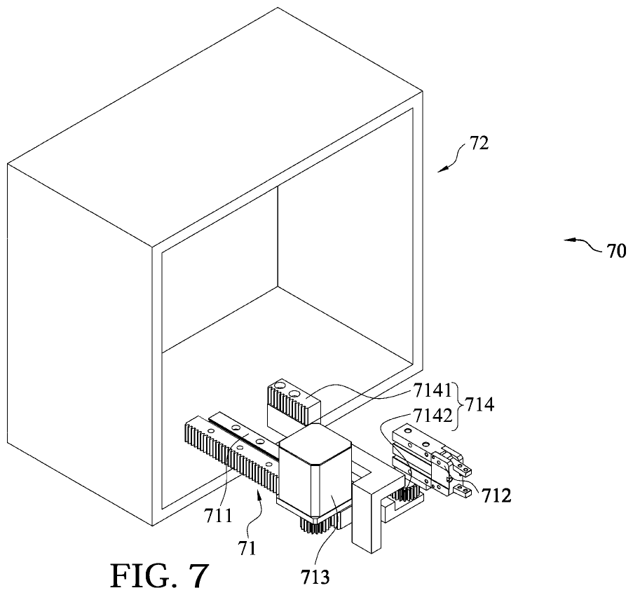

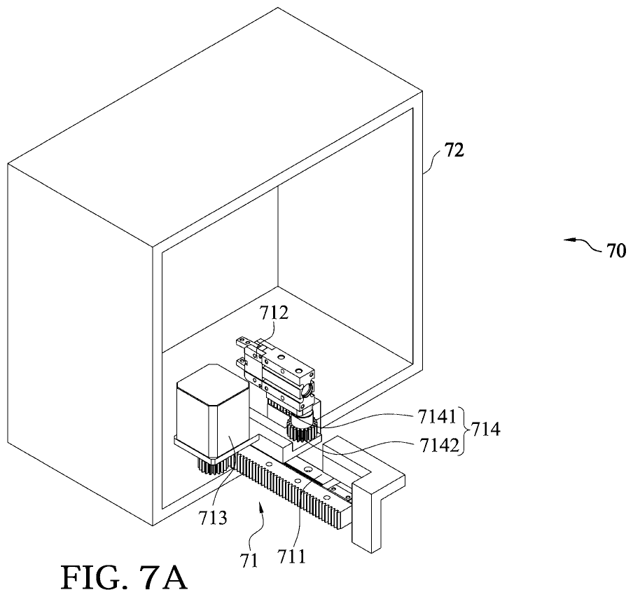

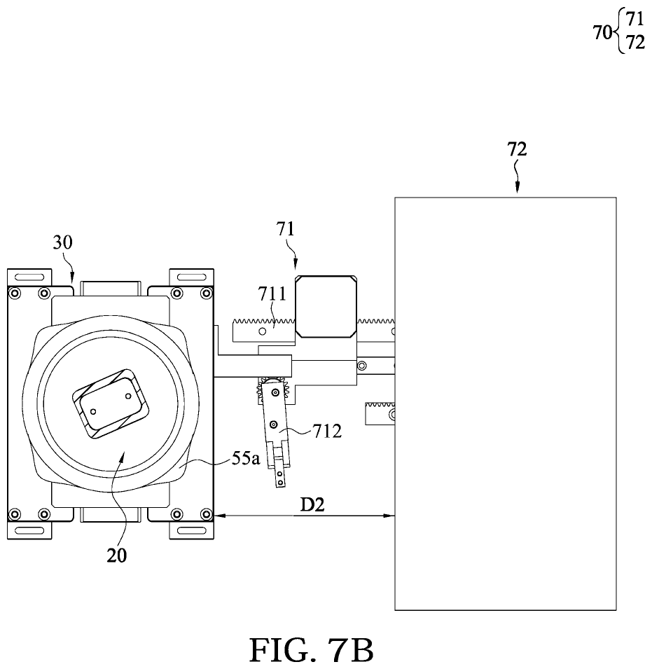

Please refer to FIG. 1, FIG. 7, and FIG. 7B. In some embodiments, the recycling module 70 comprises a clamping-receiving assembly 71 and a recycling cabin 72, and a distance D2 is between the recycling cabin 72 and the replacement module 30. When the controller 10 executes a recycle procedure, the clamping-receiving assembly 71 is actuated to move to the replacement module 30 to perform the clamping action; the controller 10 further actuates the clamping-receiving assembly 71 to move to the recycling cabin 72 to perform a recycling action. Upon the controller 10 is executing the detaching procedure or after the controller 10 executes the detaching procedure, the controller 10 executes the recycling procedure. Therefore, after the snap ring 22 and the used wiping cloth 55a are detached, the used wiping cloth 55a is clamped by the clamping-receiving assembly 71 and is placed in the recycling cabin 72.

Please refer to FIG. 1, FIG. 7, and FIG. 7B. In some embodiments, the clamping-receiving assembly 71 comprises a fourth rail 711, a second clamp 712, and a fourth power unit 713. The fourth rail 711 is between the replacement module 30 and the recycling cabin 72, the fourth power unit 713 is disposed on the fourth rail 711, and the fourth power unit 713 is power-connected to the second clamp 712. Therefore, the fourth power unit 713 drives the second clamp 712 to move along the fourth rail 711, and the used wiping cloth 55a is taken back to the recycling cabin 72 for recycling.

Please refer to FIG. 7, FIG. 7A, and FIG. 7B. In some embodiments, the clamping-receiving assembly 71 comprises a steering unit 714. The steering unit 714 comprises a steering rack 7141 and a gear 7142, the steering rack 7141 is on one side of the fourth rail 711, the steering rack 7141 is parallel to the fourth rail 711, and the gear 7142 is disposed on the second clamp 712. The second clamp 712 is pivotally connected to the fourth power unit 713. During the movement of the second clamp 712 along the fourth rail 711, the steering rack 7141 drives the gear 7142 to rotate so as to allow the second clamp 712 to rotate, thereby facilitating the used wiping cloth 55a to be recycled in the recycling cabin 72. As shown in FIG. 7 and FIG. 7A, in some embodiments, the rotation of the second clamp 712 is 180 degree rotation.

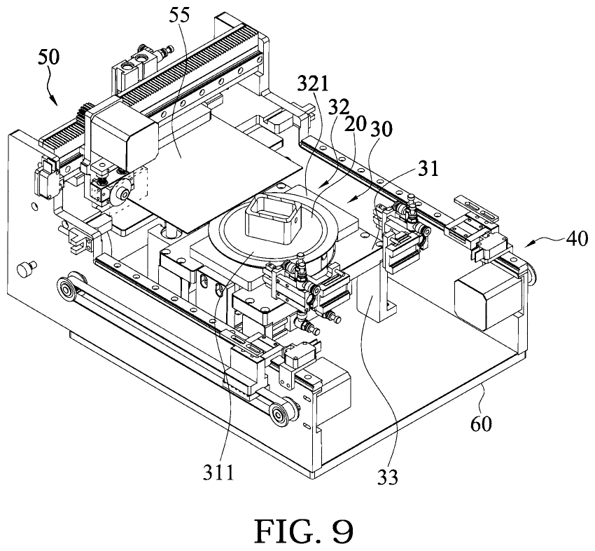

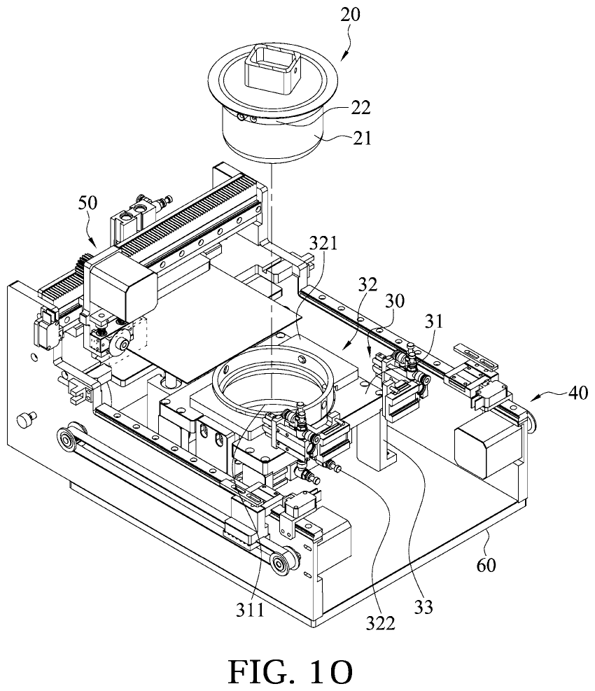

Please refer to FIG. 1, FIG. 4, and FIG. 8. According to one or some embodiments of the instant disclosure, upon replacing the used wiping cloth 55a, the controller 10 first actuates the robotic arm 20 to move toward the receiving portion 311 to allow the wiping head 21 to enter the receiving portion 311, and the snap ring 22 abuts against the hole edge of the receiving portion 311. Please refer to FIG. 1, FIG. 3A, and FIG. 9. The controller 10 actuates the engaging member 321 to move to the engaged position P1, then, as shown in FIG. 4 and FIG. 1, the flange 324 of the engaging member 321 is engaged with the upper edge of the snap ring 22, and the clamping surface 323 of the engaging member 321 clamps the peripheral portion of the snap ring 22. Please refer to FIG. 1, FIG. 4, and FIG. 10. Then, the controller 10 actuates the robotic arm 20 to move upward and away from the receiving portion 311. Under such condition, because of the flange 324 and the clamping surface 323, the snap ring 22 is not moved. Therefore, when the robotic arm 20 is moved away from the receiving portion 311, the snap ring 22 and the used wiping cloth 55a are detached from the wiping head 21. Next, as shown in FIG. 1, FIG. 7, and FIG. 7A, the fourth power unit 713 drives the second clamp 712 to move toward the replacement module 30 and clamp the used wiping cloth 55a. Then, the fourth power unit 713 further drives the second clamp 712 to move away from the replacement module 30. During the movement of the second clamp 712, the gear 7142 is engaged with the steering rack 7141, thereby making the second clamp 712 rotate toward the recycling cabin 72 and place the wiping cloth 55 in the recycling cabin 72.

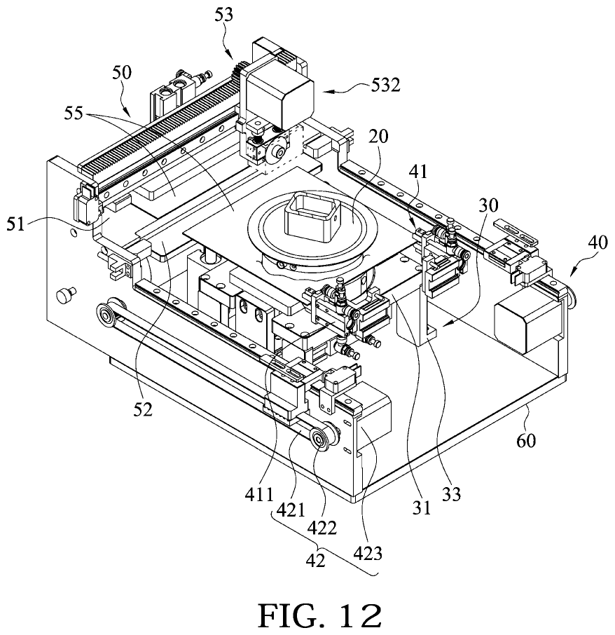

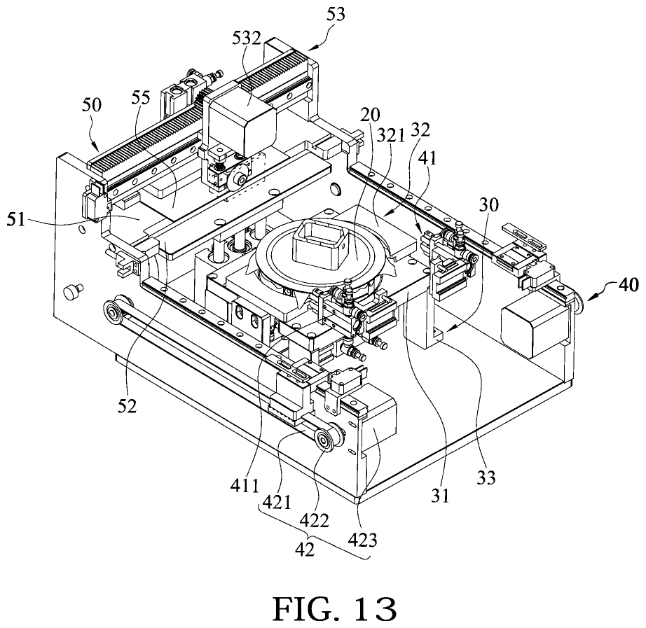

Then, as shown in FIG. 1, FIG. 6 and FIG. 11, the controller 10 actuates the clamping-pulling module 40, so that the first clamp 411 moves toward the supply module 50 to clamp the wiping cloth 55. Next, the controller 10 actuates the clamping-pulling module 40 to move to the fourth position P3, and the wiping cloth 55 gradually expands and falls in the receiving portion 311. As shown in FIG. 5A and FIG. 5B, under this condition, the controller 10 actuates the supply module 50, so that the first pressing plate 52 presses the wiping cloth 55 upward and the second pressing plate 56 presses the wiping cloth 55 downward. Therefore, a tension is generated on the wiping cloth 55 between the first pressing plate 52 and the second pressing plate 56. Next, the controller 10 actuates the cutting assembly 53 to move, so that the round knife 5322 is moved along the cutting direction L1 to cut the wiping cloth 55. As shown in FIG. 4, FIG. 12 and FIG. 13, then the controller 10 actuates the robotic arm 20 to move downward and move toward the receiving portion 311, so that the wiping head 21 gradually enter the interior of the receiving portion 311. During the movement of the robotic arm 20, the wiping cloth 55 gradually encloses the wiping head 21. Moreover, after the wiping head 21 completely entered the receiving portion 311, the snap ring 22 is closely engaged with the wiping cloth 55 and the wiping head 21. As shown in FIG. 3A and FIG. 3B, then the controller 10 actuates the engaging member 321 to leave the engaged position P1. Next, the controller 10 further actuates the robotic arm 20 to move away from the receiving portion 311. Accordingly, the replacement of the wiping cloth 55 can be achieved effectively. Moreover, for showing the foregoing operations, in FIG. 8 to FIG. 13, the recycling module 70 is not shown.

According to one or some embodiments of the instant disclosure, a cloth replacement mechanism is further provided. The cloth replacement mechanism comprises a frame body 80, a replacement module 30, a clamping-pulling module 40, and a supply module 50. The replacement module 30 comprises a base body 31, and the base body 31 has a receiving portion 311. The clamping-pulling module 40 is movably disposed on the frame body 80. The supply module 50 comprises a cutting assembly 53, and the cutting assembly 53 is movably disposed on the frame body 80.

Please refer to the foregoing paragraphs for the operation, advantages, and embodiments of the cloth replacement mechanism, which will not be iterated here.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A cloth replacement apparatus comprising:
a frame body;
a robotic arm comprising a wiping head;
a replacement module disposed on the frame body and comprising:
a base body having a receiving portion, wherein the wiping head is selectively received in the receiving portion;
a clamping-pulling module movably disposed on the frame body; and
a supply module comprising:
a cutting assembly movably disposed on the frame body.

2. The cloth replacement apparatus according to claim 1, wherein the cutting assembly comprises a first rail, a round knife assembly, and a first power unit; the first power unit is disposed on the first rail; the round knife assembly is connected to the first power unit.

3. The cloth replacement apparatus according to claim 2, wherein the round knife assembly comprises a housing and a round knife, and the round knife is disposed on the housing and protrudes out of a bottom surface of the housing.

4. The cloth replacement apparatus according to claim 1, wherein the supply module comprises a first pressing plate, a second pressing plate, and a loading plate, and the cutting assembly is between the first pressing plate and the second pressing plate; the first pressing plate and the second pressing plate are selectively moved with respect to the loading plate.

5. The cloth replacement apparatus according to claim 1, wherein the robotic arm comprises a snap ring fitted over the wiping head; the replacement module comprises an engaging assembly, and the engaging assembly comprises an engaging member; the engaging member has a clamping surface, and a flange is on the clamping surface; the snap ring be pushed selectively by the flange.

6. The cloth replacement apparatus according to claim 1, wherein the clamping-pulling module comprises a clamping assembly and a moving assembly; the moving assembly comprises a drive belt, two drive wheels, and a third power unit, the two drive wheels are arranged separately, the drive belt is arranged over the two drive wheels, and the third power unit is power-connected to one of the two drive wheels; the clamping assembly is disposed on the drive belt and between the two drive wheels.

7. The cloth replacement apparatus according to claim 6, wherein the clamping assembly comprises a first clamp and a third rail, and the first clamp is slidably disposed on the third rail.

8. The cloth replacement apparatus according to claim 1, further comprising a recycling module, wherein the recycling module comprises a clamping-receiving assembly and a recycling cabin, and a distance is between the recycling cabin and the replacement module;
the clamping-receiving assembly comprises a fourth rail, a second clamp, and a fourth power unit, the fourth rail is between the replacement module and the recycling cabin, and the fourth power unit is disposed on the fourth rail and power-connected to the second clamp.

9. The cloth replacement apparatus according to claim 8, wherein the clamping-receiving assembly comprises a steering unit, the steering unit comprises a steering rack and a gear, the steering rack is disposed on one side of the fourth rail, and the gear is disposed on the second clamp; the second clamp is pivotally connected to the fourth rail.

10. The cloth replacement apparatus according to claim 1, wherein the robotic arm comprises a connection member, and the connection member has a first pin hole and a magnet; an insertion groove and a pin are on a top portion of the wiping head, one side of the insertion groove has a second pin hole, and the pin selectively and sequentially passes through the second pin hole and the first pin hole.

11. A cloth replacement mechanism comprising:
a frame body;
a replacement module disposed on the frame body and comprising:
a base body comprising an engaging assembly, wherein the engaging assembly is movable;
a clamping-pulling module movably disposed on the frame body; and
a supply module comprising:
a cutting assembly movably disposed on the frame body.

12. The cloth replacement mechanism according to claim 11, wherein the cutting assembly comprises a first rail, a round knife assembly, and a first power unit; the first power unit is disposed on the first rail; the round knife assembly is disposed on the first power unit.

13. The cloth replacement mechanism according to claim 12, wherein the round knife assembly comprises a housing and a round knife, and the round knife is disposed on the housing and protrudes out of a bottom surface of the housing.

14. The cloth replacement mechanism according to claim 11, wherein the supply module comprises a first pressing plate, a second pressing plate, and a loading plate, and the cutting assembly is between the first pressing plate and the second pressing plate; the first pressing plate and the second pressing plate are selectively moved with respect to the loading plate.

15. The cloth replacement mechanism according to claim 11, wherein the engaging assembly comprises an engaging member, the engaging member has a clamping surface, and a flange is on the clamping surface.

16. The cloth replacement mechanism according to claim 11, wherein the clamping-pulling module comprises a clamping assembly and a moving assembly; the moving assembly comprises a drive belt, two drive wheels, and a third power unit, the two drive wheels are arranged separately, the drive belt is arranged over the two drive wheels, and the third power unit is power-connected to one of the two drive wheels; the clamping assembly is disposed on the drive belt and between the two drive wheels.

17. The cloth replacement mechanism according to claim 16, wherein the clamping assembly comprises a first clamp and a third rail, and the first clamp is slidably disposed on the third rail.

18. The cloth replacement mechanism according to claim 11, further comprising a recycling module, wherein the recycling module comprises a clamping-receiving assembly and a recycling cabin, and a distance is between the recycling cabin and the replacement module.

19. The cloth replacement mechanism according to claim 18, wherein the clamping-receiving module comprises a fourth rail, a second clamp, and a fourth power unit, the fourth rail is between the replacement module and the recycling cabin, the second clamp is disposed on the fourth rail, and the fourth power unit is power-connected to the second clamp.

20. The cloth replacement mechanism according to claim 19, wherein the clamping-receiving assembly comprises a steering unit, the steering unit comprises a steering rack and a gear, the steering rack is disposed on one side of the fourth rail, the gear is disposed on the second clamp, and the gear is adapted to be engaged with the steering rack; the second clamp is pivotally connected to the fourth rail.
